(19) United States
(12) Patent Application Publication
(10) Pub. No.: US 2024/0367476 A1
(43) Pub. Date: Nov. 7, 2024

(54) TEMPERING SYSTEM, IN PARTICULAR FOR A VEHICLE

(71) Applicant: Eberspächer Sütrak GmbH & Co. KG, Renningen (DE)

(72) Inventors: Sebastian De La Coba Denninger, Ludwigsburg (DE); Marcel Knipps, Herrenberg (DE)

(21) Appl. No.: 18/655,031

(22) Filed: May 3, 2024

(30) Foreign Application Priority Data
May 4, 2023 (DE) 10 2023 111 565.0
Jul. 28, 2023 (DE) 10 2023 120 143.3

(51) Int. Cl. B60H 1/00; B60H 1/24

(52) U.S. Cl. CPC B60H 1/00042; B60H 1/00335; B60H 1/248

(57) ABSTRACT

A tempering system includes a refrigerant circuit with a heat-emitting heat exchanger around which air to be heated can flow, and a heat-absorbing heat exchanger around which air to be cooled can flow, and an air guide arrangement for optionally conducting exhaust air extracted from an interior to be thermally conditioned via the heat-emitting heat exchanger or the heat-absorbing heat exchanger and for optionally conducting fresh air via the heat-absorbing heat exchanger or the heat-emitting heat exchanger. The air guide arrangement is configured such that in a fresh air heating mode, fresh air to be conducted into the interior to be thermally conditioned is conducted as air to be heated via the heat-emitting heat exchanger and exhaust air to be extracted from the interior to be thermally conditioned is conducted as air to be cooled via the heat-absorbing heat exchanger.

### CROSS-REFERENCE TO RELATED APPLICATIONS

This application claims priority of German patent application nos. 10 2023 111 565.0, filed May 4, 2023, and 10 2023 120 143.3, filed Jul. 28, 2023, the entire content of both applications is incorporated herein by reference.

### TECHNICAL FIELD

The present disclosure concerns a tempering system, in particular for a vehicle, including at least one refrigerant circuit with at least one heat-emitting heat exchanger arrangement around which air to be heated can flow, and at least one heat-absorbing heat exchanger arrangement around which air to be cooled can flow, and an air guide arrangement for optional conduction of waste air extracted from an interior to be thermally conditioned through the at least one heat-emitting heat exchanger arrangement or the at least one heat-absorbing heat exchanger arrangement, and for optional conduction of fresh air through the at least one heat-absorbing heat exchanger arrangement or the at least one heat-emitting heat exchanger arrangement.

### BACKGROUND

Such a tempering system is known from US 2017/0259642. This known tempering system is shown in heating mode in FIG. 2. In this tempering system generally designated 10, which is configured to heat an interior 12 of a bus 14, a refrigerant circuit 16 (shown schematically) includes, successively in the flow direction, a compressor 18, one or more mutually parallel-connected heat-emitting heat exchanger arrangements 20, an expansion valve 22, and one or more mutually parallel-connected heat-absorbing heat exchanger arrangements 24. For thermal conditioning of the interior 12, the heat-absorbing heat exchanger arrangement 24 may act or be operated as an evaporator heat exchanger arrangement, and the heat-emitting heat exchanger arrangement 20 may act or be operated as a condenser heat exchanger arrangement. In the region of the heat-emitting heat exchanger arrangement 20, heat is emitted from the refrigerant circulating in the refrigerant circuit 16 and transmitted to the air flowing around the heat-emitting heat exchanger arrangement 20, while the heat-absorbing heat exchanger arrangement 24 receives heat from the air flowing around it and transmits it to the refrigerant. The air flowing around the heat-emitting heat exchanger arrangement 20 is heated while the air flowing around the heat-absorbing heat exchanger arrangement 24 is cooled.

The tempering system 10 furthermore includes an air guide arrangement, generally designated 26. The air guide arrangement 26 includes a first flap arrangement 28 assigned to the heat-emitting heat exchanger arrangement 20, and a second flap arrangement 30 assigned to the heat-absorbing heat exchanger arrangement 24.

The first flap arrangement 28 includes three adjustable air guide flaps 32, 34, 36. Similarly, the second flap arrangement 30 includes three adjustable air guide flaps 38, 40, 42.

The first air guide flap 32 of the first flap arrangement 32 can be pivoted between a position shown in FIG. 2, in which it opens a flow path on the interior 12 to the heat-emitting heat exchanger arrangement 20 and blocks a flow path from an external environment to the heat-emitting heat exchanger arrangement 20, and a position in which it blocks the flow path from the interior 12 to the heat-emitting heat exchanger arrangement 20 while opening the flow path from the external environment to the heat-emitting heat exchanger arrangement 20.

The second air guide flap 34 can be switched between a position shown in FIG. 2, in which it blocks a flow path from the heat-emitting heat exchanger arrangement 20 to a discharge volume 44, and a position in which it opens the flow path from the heat-emitting heat exchanger arrangement 20 to the discharge volume 44.

The third air guide flap 36 of the first flap arrangement 28 can be moved between a position shown in FIG. 2, in which it opens a flow path from the heat-emitting heat exchanger arrangement 20 to a supply volume 46, and a position in which it blocks the flow path from the heat-emitting heat exchanger arrangement 20 to the supply volume 46.

In the heating mode of the tempering system 10, shown in FIG. 2, the air guide flaps 32, 34, 36 of the first flap arrangement 28 are set such that air extracted from the interior 12 flows as recirculation air U to the heat-emitting heat exchanger arrangement 20, receives heat there and is conveyed back to the interior 12 via the supply volume 46 and a supply fan arrangement 48.

The fourth air guide flap 38 of the second flap arrangement 30 can be pivoted between a position shown in FIG. 2, in which it opens a flow path from the external environment to the heat-absorbing heat exchanger arrangement 24 and blocks a flow path from the interior 12 to the heat-absorbing heat exchanger arrangement 24, and a position in which it blocks the flow path from the external environment to the heat-absorbing heat exchanger arrangement 24 while opening the flow path from the interior 12 to the heat-absorbing heat exchanger arrangement 24.

The fifth air guide flap 40 of the second flap arrangement 30 can be switched between a position shown in FIG. 2, in which it opens a flow path from the heat-absorbing heat exchanger arrangement 24 to the discharge volume 44, and a position in which it blocks the flow path from the heat-absorbing heat exchanger arrangement 24 to the discharge volume 44.

The sixth air guide flap 42 of the second flap arrangement 30 can be moved between a position shown in FIG. 2, in which it blocks a flow path from the heat-absorbing heat exchanger arrangement 24 to the supply volume 46, and a position in which it opens the flow path from the heat-absorbing heat exchanger arrangement 24 to the supply volume 46.

In the heating mode of the tempering system 10 shown in FIG. 2, fresh air F drawn in from the outside flows through the heat-absorbing heat exchanger arrangement 24, where it emits heat to the refrigerant circulating in the refrigerant circuit 16, and leaves the discharge volume 44 in the direction of the external environment under the conveying effect of a discharge fan arrangement 50.

### SUMMARY

An object of the present disclosure is to provide a tempering system and a method for operating a tempering system with which an increased efficiency is achieved for thermal conditioning of an interior.

According to a first aspect of the present disclosure, this object is achieved by a tempering system, in particular for a vehicle, including:
at least one refrigerant circuit with at least one heat-emitting heat exchanger arrangement around which air to be heated can flow, and at least one heat-absorbing heat exchanger arrangement around which air to be cooled can flow,
an air guide arrangement for optional conduction of waste air extracted from an interior to be thermally conditioned through the at least one heat-emitting heat exchanger arrangement or the at least one heat-absorbing heat exchanger arrangement, and for optional conduction of fresh air through the at least one heat-absorbing heat exchanger arrangement or the at least one heat-emitting heat exchanger arrangement.

In the tempering system according to the disclosure, the air guide arrangement is configured such that in a fresh air heating mode, fresh air to be conducted into the interior to be thermally conditioned is conducted as at least part of the air to be heated, preferably as all the air to be heated, through the at least one heat-emitting heat exchanger arrangement, and waste air to be extracted from the interior to be thermally conditioned is conducted as at least part of the air to be cooled, preferably as all the air to be cooled, through the at least one heat-absorbing heat exchanger arrangement.

Alternatively or additionally, in the tempering system according to the disclosure, the guide arrangement is configured such that in a fresh air cooling mode, fresh air to be conducted into the interior to be thermally conditioned is conducted as at least part of the air to be cooled through the at least one heat-absorbing heat exchanger arrangement, and waste air to be extracted from the interior to be thermally conditioned is conducted as at least part of the air to be heated through the at least one heat-emitting heat exchanger arrangement.

The tempering system according to the disclosure also works efficiently as a heat pump in fresh air heating mode, that is, a heating mode in which at least a part of the air to be heated and conducted into the interior has not previously been extracted from the interior as recirculation air, but is extracted as fresh air from outside the interior to be thermally conditioned, for example from an external environment. In a state in which an interior of, for example, a vehicle is to be heated or kept warm, it is assumed that the waste air extracted from the interior in fresh air heating mode and to be replaced by fresh air has a higher temperature than the fresh air drawn in from the external environment. By conducting the comparatively warm waste air, to be replaced by fresh air to be heated, through the at least one heat-absorbing heat exchanger arrangement, this can extract heat from the comparatively warm waste air in heat pump mode of the tempering system, and transmit it to the fresh air to be conducted into the interior. Thus in comparison with a fresh air heating mode in which the heat to be transmitted to the fresh air to be heated and conducted into the interior is extracted from a fresh air stream received from the external environment, conducted through the at least one heat-absorbing heat exchanger arrangement and then discharged again to the environment, the tempering system as an air heat pump is operated at an operating point at which it has a significantly higher efficiency.

Accordingly, also in fresh air cooling mode, the tempering system constructed according to the disclosure can work as a heat pump in order to use the waste air to be extracted for example from a cooled interior of the vehicle as a heat carrier, to which heat extracted from the fresh air to be cooled and conducted into the interior can be transmitted.

In order, in fresh air heating mode, to convey into the interior the fresh air to be heated and conducted into the interior, it is proposed that a supply fan arrangement is provided for conveying, in fresh air heating mode, fresh air to be conducted into the interior to be thermally conditioned so as to flow around the at least one heat-emitting heat exchanger arrangement. Alternatively or additionally, the supply fan arrangement may be provided for conveying, in fresh air cooling mode, fresh air to be conducted into the interior to be thermally conditioned so as to flow around the at least one heat-absorbing heat exchanger arrangement.

To conduct thermally conditioned air, in particular also the fresh air heated in fresh air heating mode or the fresh air cooled in fresh air cooling mode, into the interior, a supply volume may be provided for receiving the fresh air conveyed by the supply fan arrangement in fresh air heating mode so as to flow around the at least one heat-emitting heat exchanger arrangement and for emitting the fresh air heated by the at least one heat-emitting heat exchanger arrangement to the interior to be thermally conditioned, and/or for receiving the fresh air conveyed by the supply fan arrangement in fresh air cooling mode so as to flow around the at least one heat-absorbing heat exchanger arrangement and for emitting the fresh air cooled by the at least one heat-absorbing heat exchanger arrangement to the interior to be thermally conditioned.

To discharge air from the interior, in particular also to discharge the waste air to be discharged to the outside, that is, to the external environment, in fresh air heating mode, a discharge fan arrangement may be provided for conveying waste air to be extracted from the interior to be thermally conditioned in fresh air heating mode so as to flow around the at least one heat-absorbing heat exchanger arrangement. Alternatively or additionally, the discharge fan arrangement may be provided for conveying waste air to be extracted from the interior to be thermally conditioned in fresh air cooling mode so as to flow around the at least one heat-emitting heat exchanger arrangement.

Here, a discharge volume may be provided for receiving the waste air conveyed by the discharge fan arrangement in fresh air heating mode so as to flow around the at least one heat-absorbing heat exchanger arrangement and for emitting the waste air cooled by the at least one heat-absorbing heat exchanger arrangement to an external environment, and/or for receiving waste air conveyed by the discharge fan arrangement in fresh air cooling mode so as to flow around the at least one heat-emitting heat exchanger arrangement and for emitting the waste air heated by the at least one heat-emitting heat exchanger arrangement to an external environment.

For defined setting of the air flows, in particular in fresh air heating mode, the guide arrangement assigned to the at least one heat-emitting heat exchanger arrangement may include a first flap arrangement for optional conduction of the air flowing around the at least one heat-emitting heat exchanger arrangement into the supply volume or into the discharge volume, and/or the guide arrangement assigned to the at least one heat-absorbing heat exchanger arrangement may include a second flap arrangement for optional conduction of the air flowing around the at least one heat-absorbing heat exchanger arrangement into the supply volume or into the discharge volume.

In order in the various operating modes to be able to guarantee the function of the refrigerant circuit as a heat pump in a wide temperature spectrum, it is proposed that the refrigerant circuit contains CO2 as refrigerant.

The disclosure furthermore concerns a vehicle, in particular a bus, including a tempering system constructed according to the disclosure.

According to a further aspect, the object cited initially is achieved by a method for thermal conditioning of an interior via a tempering system, constructed, for example, according to the present disclosure, wherein the tempering system includes at least one refrigerant circuit with at least one heat-emitting heat exchanger arrangement around which air to be heated can flow, and at least one heat-absorbing heat exchanger arrangement around which air to be cooled can flow, and an air guide arrangement for optional conduction of waste air extracted from an interior to be thermally conditioned through the at least one heat-emitting heat exchanger arrangement or the at least one heat-absorbing heat exchanger arrangement, and for optional conduction of fresh air through the at least one heat-absorbing heat exchanger arrangement or the at least one heat-emitting heat exchanger arrangement, in which method:
in a fresh air heating mode, fresh air to be conducted into the interior to be thermally conditioned is conducted as at least part of the air to be heated, preferably as all the air to be heated, through the at least one heat-emitting heat exchanger arrangement, and waste air to be extracted from the interior to be thermally conditioned is conducted as at least part of the air to be cooled, preferably as all the air to be cooled, through the at least one heat-absorbing heat exchanger arrangement, and/or
in a fresh air cooling mode, fresh air to be conducted into the interior to be thermally conditioned is conducted as at least part of the air to be cooled through the at least one heat-absorbing heat exchanger arrangement, and waste air to be extracted from the interior to be thermally conditioned is conducted as at least part of the air to be heated through the at least one heat-emitting heat exchanger arrangement.

### BRIEF DESCRIPTION OF DRAWINGS

The invention will now be described with reference to the drawings wherein:

FIG. 1 shows a general illustration of a tempering system in a fresh air heating mode;

FIG. 2 shows an illustration corresponding to FIG. 1 of a tempering system known from the prior art in a heating mode; and,

FIG. 3 shows an illustration corresponding to FIG. 1 of the tempering system in a fresh air cooling mode.

### DETAILED DESCRIPTION

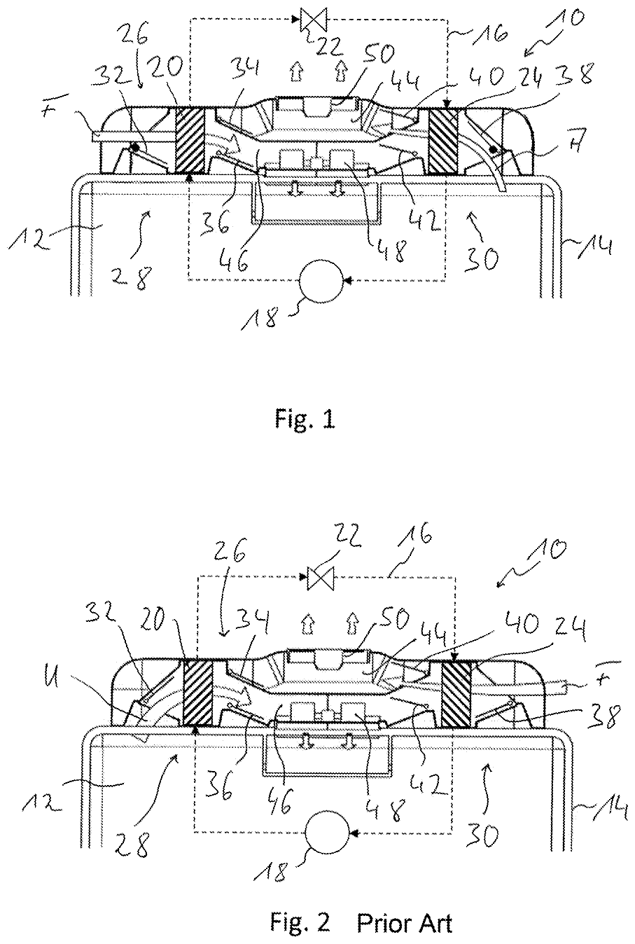

The structure or operation of a tempering system is described below with reference to FIG. 1, wherein the system may be used, for example, for thermal conditioning of a bus and in its fundamental structure may be configured as the tempering system 10 described above with reference to FIG. 2. Therefore with respect to the fundamental configuration of the tempering system 10 of FIG. 1, described in more detail below with respect to a fresh air heating mode, reference is made to the above statements in relation to FIG. 2. Components with structure or function corresponding to the components described above with reference to FIG. 2 carry the same reference signs in FIG. 1.

FIG. 1 shows a tempering system 10 in a fresh air heating mode in which, in principle, the interior 12 of the bus 14 is to be heated, but the air to be heated and introduced into the interior 12 has not previously been extracted from the interior 12 as circulated air, but supplied from the external environment as fresh air F. It is pointed out that in the sense of the present disclosure, such a fresh air heating mode also includes a mode in which a part of the air to be heated and conducted into the interior is supplied as fresh air F from the external environment, while a further part is extracted from the interior 12 as recirculation air and returned thereto.

FIG. 2 shows that the air guide arrangement 26 is set such that the first air guide flap 32 of the first flap arrangement 28 blocks the flow path from the interior 12 to the heat-emitting heat exchanger arrangement 20, while the flow path from the external environment to the heat-emitting heat exchanger arrangement 20 is open. Under the conveying effect of the supply fan arrangement 48, fresh air F from the external environment is conveyed through the heat-emitting heat exchanger arrangement 20 into the supply volume 46 and via this into the interior 12 of the bus 14. When flowing around the heat-emitting heat exchanger arrangement 20 of the refrigerant circuit 16, the fresh air F absorbs heat from the refrigerant circulating in the refrigerant circuit 16 and, thus heated, enters the interior 12. For this, the second air guide flap 34 and the third air guide flap 36 of the first flap arrangement 28 are set such that the second air guide flap 34 blocks the flow path to the discharge volume 44 while the third air guide flap 36 opens the flow path to the supply volume 46.

In the second flap arrangement 30 of the air guide arrangement 26, the fourth air guide flap 38 is set such that it opens the flow path from the interior 12 to the heat-absorbing heat exchanger arrangement 24 and blocks the flow path from the external environment to the heat-absorbing heat exchanger arrangement 24. The fifth air guide flap 40 of the second flap arrangement 30 is set such that it opens the flow path from the heat-absorbing heat exchanger arrangement 24 to the discharge volume 44, and the sixth air guide flap 42 of the second flap arrangement 30 is set such that it blocks the flow path from the heat-absorbing heat exchanger arrangement 24 to the supply volume 46, and conducts the waste air A, extracted from the interior 12 and flowing through the heat-absorbing heat exchanger arrangement 24, in the direction towards the discharge volume 44. Under the conveying effect of the discharge fan arrangement 50, the waste air A, extracted from the interior 12 and conducted through the heat-absorbing heat exchanger arrangement 24, flows via the discharge volume 44 to the external environment. In doing so, heat is extracted from the waste air A extracted from the interior 12 at the heat-absorbing heat exchanger arrangement 24, and transmitted to the refrigerant in the refrigerant circuit 16, which then in turn can transmit it to the fresh air F to be conducted into the interior 12 at the heat-emitting heat exchanger arrangement 20 in heat pump mode of the refrigerant circuit 16.

By operating the tempering system 10 in a fresh air heating mode in which heat to be transmitted to the fresh air F to be conducted into the interior 12 is taken from the comparatively warm waste air A extracted from the interior 12, it is possible to operate the refrigerant circuit 16 in heat pump mode at an operating point which allows a comparatively high efficiency. In order to guarantee that heat pump mode is possible over a broad range of temperature of the fresh air F, advantageously CO2 is used as a refrigerant in the refrigerant circuit 16. The thermal energy contained in the waste air A to be discharged from the interior 12 is therefore not—as is the case in conventional buses-emitted to the external environment as heat losses with the otherwise unused waste air A, but is used to increase the efficiency of the tempering system 10 for heating the fresh air F to be conducted into the interior 12.

If, in this fresh air heating mode, a part of the air to be conducted into the interior 12 is provided by recirculation air previously extracted from the interior 12, while another part of the fresh air is supplied from the external environment, at the first flap arrangement 28, the first air guide flap 32 may be set to a position in which it completely blocks neither the flow path from the interior 14 to the heat-emitting heat exchanger 20 nor the flow path from the external environment to the heat-emitting heat exchanger arrangement 20. Thus under the conveying effect of the supply fan arrangement 48, a mixture of fresh air F and recirculation air can be conducted through the heat-emitting heat exchanger arrangement 20 and back-heated-to the interior 12. Depending on the positioning of the first air guide flap 32, the ratio of fresh air F to recirculation air can be set.

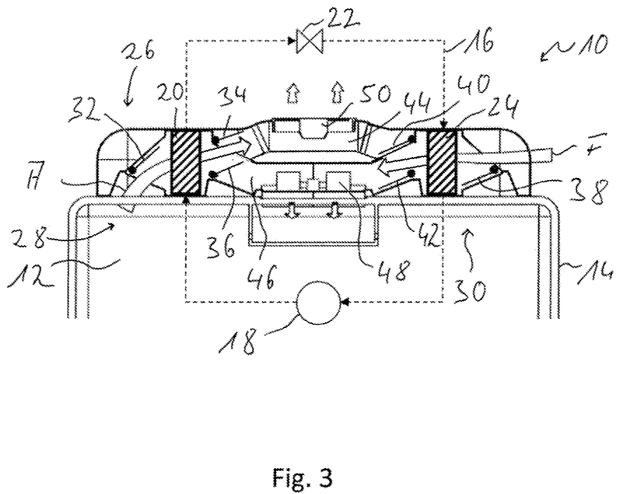

It is pointed out that the tempering system 10 shown in FIG. 1 can evidently also be operated in other operating modes. For example, in recirculation air heating mode or recirculation air cooling mode shown in FIG. 2, or in fresh air cooling mode illustrated in FIG. 3. In fresh air mode, the air guide flaps 38, 40, 42 of the flap arrangement 30 are set such that fresh air F drawn in from the outside flows through the heat-absorbing heat exchanger arrangement 24 and emits heat to the refrigerant circulating in the refrigerant circuit 16. Then, under the conveying effect of the supply fan arrangement 48, the cooled fresh air F flows in the direction of the supply air volume 46 and from there into the interior 12.

The waste air A to be extracted from the interior 12 and replaced by fresh air F is conducted by the air guide flaps 32, 34, 36 of the flap arrangement 28 out of the interior 12 through the heat-emitting heat exchanger arrangement 20 in the direction of the discharge volume 44. On flowing through the heat-emitting heat exchanger arrangement 20, the waste air A receives heat from the heat transfer medium circulating in the heat transfer medium circuit 16, and then flows to the outside under the conveying effect of the discharge fan arrangement 50.

The fresh air heating mode or fresh air cooling mode, described with reference to the embodiment of the tempering system shown in FIGS. 1 and 3, can also be achieved with a tempering system in which the refrigerant circuit with the various types of heat exchanger arrangements is operated such that, depending on the circulation direction of the refrigerant, each of the heat exchanger arrangements can be operated either as an heat-emitting heat exchanger arrangement or as a heat-absorbing heat exchanger arrangement. If for example the fresh air to be introduced into the interior 12 is to be cooled, a heat exchanger arrangement, through which it flows in this fresh air cooling mode and is conducted to the interior, is operated as heat-absorbing heat exchanger arrangement, while the other heat exchanger arrangement in this mode is operated as heat-emitting heat exchanger arrangement. If the fresh air is to be heated and conducted into the interior, the same heat exchanger arrangement is operated as a heat-emitting heat exchanger arrangement while the other heat exchanger arrangement is operated as a heat-absorbing heat exchanger arrangement. With optional conduction of the two air flows through the two types of heat exchangers, this allows widely varying operating modes to be provided with a simply structured air guide arrangement.

It should also be emphasized that the tempering system constructed or operated according to the disclosure may also be used in other applications, for example for thermal conditioning of buildings, and may be configured differently in particular with respect to the devices provided for setting the various air flows. Thus for example one or both flap arrangements 28, 30 may, instead of the pairs of air guide flaps 34, 36 or 40, 42, have only a single flap which, corresponding to the functionality of the air guide flaps 32, 38, conducts the air flowing through a respective heat exchanger arrangement 20 or 24 either in the direction towards the supply volume 46 or in the direction towards the discharge volume 44.

It is understood that the foregoing description is that of the preferred embodiments of the invention and that various changes and modifications may be made thereto without departing from the spirit and scope of the invention as defined in the appended claims.

1. A tempering system comprising:
at least one refrigerant circuit with at least one heat-emitting heat exchanger around which air to be heated can flow, and at least one heat-absorbing heat exchanger around which air to be cooled can flow;
an air guide arrangement for optional conducting of exhaust air extracted from an interior to be thermally conditioned via said at least one heat-emitting heat exchanger or the at least one heat-absorbing heat exchanger, and for optional conducting of fresh air via said at least one heat-absorbing heat exchanger or said at least one heat-emitting heat exchanger;
wherein at least one of the following applies:
i) said air guide arrangement is configured such that in a fresh air heating mode, the fresh air to be conducted into said interior to be thermally conditioned is conducted as at least part of the air to be heated via said at least one heat-emitting heat exchanger, and the exhaust air to be extracted from the interior to be thermally conditioned is conducted as at least part of the air to be cooled via said at least one heat-absorbing heat exchanger; and,
ii) said air guide arrangement is configured such that in a fresh air cooling mode, the fresh air to be conducted into the interior to be thermally conditioned is conducted as at least part of the air to be cooled via said at least one heat-absorbing heat exchanger, and the exhaust air to be extracted from the interior to be thermally conditioned is conducted as at least part of the air to be heated via said at least one heat-emitting heat exchanger.

2. The tempering system of claim 1, wherein a supply fan arrangement is provided for at least one of the following: i) conveying, in fresh air heating mode, the fresh air to be conducted into said interior to be thermally conditioned so as to flow around said at least one heat-emitting heat exchanger; and, ii) conveying, in fresh air cooling mode, the fresh air to be conducted into said interior to be thermally conditioned so as to flow around said at least one heat-absorbing heat exchanger.

3. The tempering system of claim 2, wherein a supply volume is provided for at least one of the following:
i) receiving the fresh air conveyed by said supply fan arrangement in the fresh air heating mode so as to flow around said at least one heat-emitting heat exchanger and for emitting the fresh air heated by said at least one heat-emitting heat exchanger to said interior to be thermally conditioned; and,
ii) receiving the fresh air conveyed by said supply fan arrangement in the fresh air cooling mode so as to flow around said at least one heat-absorbing heat exchanger and for emitting the fresh air cooled by said at least one heat-absorbing heat exchanger to said interior to be thermally conditioned.

4. The tempering system of claim 3, further comprising a discharge fan arrangement for at least one of the following:
i) conveying, in the fresh air heating mode, the exhaust air to be extracted from said interior to be thermally conditioned so as to flow around said at least one heat-absorbing heat exchanger; and,
ii) conveying, in the fresh air cooling mode, the exhaust air to be extracted from said interior to be thermally conditioned so as to flow around said at least one heat-emitting heat exchanger.

5. The tempering system of claim 4, further comprising a discharge volume for at least one of the following:
i) receiving the exhaust air conveyed by said discharge fan arrangement in the fresh air heating mode so as to flow around said at least one heat-absorbing heat exchanger and for emitting the exhaust air cooled by said at least one heat-absorbing heat exchanger to an external environment; and,
ii) receiving the exhaust air conveyed by said discharge fan arrangement in the fresh air cooling mode so as to flow around said at least one heat-emitting heat exchanger and for emitting the exhaust air heated by said at least one heat-emitting heat exchanger to the external environment.

6. The tempering system of claim 5, wherein at least one of the following applies: i) said air guide arrangement assigned to said at least one heat-emitting heat exchanger includes a first flap arrangement for optional conducting of the air flowing around said at least one heat-emitting heat exchanger into said supply volume or into said discharge volume; and, ii) said air guide arrangement assigned to said at least one heat-absorbing heat exchanger includes a second flap arrangement for optional conducting of the air flowing around said at least one heat-absorbing heat exchanger into said supply volume or into said discharge volume.

7. The tempering system of claim 1, wherein said refrigerant circuit contains CO2 as refrigerant.

8. The tempering system of claim 1, wherein the tempering system is for a vehicle.

9. A vehicle, including a bus, comprising a tempering system and the tempering system including:
at least one refrigerant circuit with at least one heat-emitting heat exchanger around which air to be heated can flow, and at least one heat-absorbing heat exchanger around which air to be cooled can flow;
an air guide arrangement for optional conducting of exhaust air extracted from an interior to be thermally conditioned via said at least one heat-emitting heat exchanger or the at least one heat-absorbing heat exchanger, and for optional conducting of fresh air via said at least one heat-absorbing heat exchanger or said at least one heat-emitting heat exchanger;
wherein at least one of the following applies:
i) said air guide arrangement is configured such that in a fresh air heating mode, the fresh air to be conducted into said interior to be thermally conditioned is conducted as at least part of the air to be heated via said at least one heat-emitting heat exchanger, and the exhaust air to be extracted from the interior to be thermally conditioned is conducted as at least part of the air to be cooled via said at least one heat-absorbing heat exchanger; and,
ii) said air guide arrangement is configured such that in a fresh air cooling mode, the fresh air to be conducted into the interior to be thermally conditioned is conducted as at least part of the air to be cooled via said at least one heat-absorbing heat exchanger, and the exhaust air to be extracted from the interior to be thermally conditioned is conducted as at least part of the air to be heated via said at least one heat-emitting heat exchanger.

10. A method for thermal conditioning of an interior via a tempering system, wherein the tempering system includes at least one refrigerant circuit with at least one heat-emitting heat exchanger around which air to be heated can flow, and at least one heat-absorbing heat exchanger around which the air to be cooled can flow, and an air guide arrangement for optional conducting of exhaust air extracted from an interior to be thermally conditioned via said at least one heat-emitting heat exchanger or the at least one heat-absorbing heat exchanger, and for optional conducting of the fresh air via the at least one heat-absorbing heat exchanger or the at least one heat-emitting heat exchanger, the method comprising at least one of the following steps:
i) in a fresh air heating mode, conducting the fresh air, which is to be conducted into the interior to be thermally conditioned, as at least part of the air to be heated via the at least one heat-emitting heat exchanger; and, conducting the exhaust air, which is to be extracted from the interior to be thermally conditioned, as at least part of the air to be cooled via the at least one heat-absorbing heat exchanger; and,
ii) in a fresh air cooling mode, conducting the fresh air, which is to be conducted into the interior to be thermally conditioned, as at least part of the air to be cooled via the at least one heat-absorbing heat exchanger; and, conducting the exhaust air, which is to be extracted from the interior to be thermally conditioned, as at least part of the air to be heated via the at least one heat-emitting heat exchanger.
